(19) United States
(12) Patent Application Publication
(10) Pub. No.: US 2026/0313540 A1
(43) Pub. Date: Oct. 8, 2026

(54) LOW-LATENCY SERVICE TRANSMISSION METHOD, ELECTRONIC DEVICE, AND STORAGE MEDIUM

(71) Applicant: BEIJING XIAOMI MOBILE SOFTWARE CO., LTD., Beijing (CN)

(72) Inventor: Yajun CHENG, Beijing (CN)

(21) Appl. No.: 19/478,740

(22) PCT Filed: Apr. 27, 2023
(86) PCT No.: PCT/CN2023/091394

§ 371 Date: Oct. 24, 2025

(51) Int. Cl. H04W 52/02; H04W 72/0446; H04W 84/12

(52) U.S. Cl. CPC H04W 52/0216; H04W 72/0446; H04W 84/12

(57) ABSTRACT

The low-latency service transmission method is performed by an access point device (AP), and the method includes: determining a first wireless frame, in which the first wireless frame includes first identification information, the first identification information identifies that the AP allocates a TXOP time slot to a first TDLS device, the TXOP time slot is used for the first TDLS device and a second TDLS device to transmit a first low-latency service by means of a TDLS link, the first TDLS device is a member of first R-TWT schedule, and a second service identifier of a second low-latency service mapped between the AP and the member of the first R-TWT schedule includes a first service identifier of the first low-latency service; and transmitting the first wireless frame.

### CROSS-REFERENCE TO RELATED APPLICATION

The present application is a U.S. national phase of International Application No. PCT/CN2023/091394, filed with the State Intellectual Property Office of P. R. China on Apr. 27, 2023, the contents of which are incorporated herein by reference in their entireties for all purposes.

### TECHNICAL FIELD

The embodiments of the present disclosure relate to a field of mobile communication technologies, and particularly to a low-latency traffic transmission method, an electronic device, and a storage medium.

### BACKGROUND

Data transmission can be performed in a peer to peer (P2P) communication mode without an access point, thus avoiding a delay caused by network congestion and further improving transmission efficiency. To ensure transmission of low-latency traffic data, the wireless local area network (WLAN) proposes restricted target wake time (R-TWT). In order to further reduce low-latency traffic and a transmission delay during the data transmission, the transmission process also needs to be optimized.

### SUMMARY

In an aspect, the embodiments of the present disclosure provide a low-latency traffic transmission method performed by an access point (AP), and the method includes:

determining a first wireless frame, in which the first wireless frame includes first identification information, and the first identification information identifies that the AP allocates a slot of a transmission opportunity (TXOP) to a first tunneled direct link setup (TDLS) device;
in which the slot of the TXOP is used for the first TDLS device and a second TDLS device to transmit a first low-latency traffic via a TDLS link; the first TDLS device is a member of a first restricted target wake time (R-TWT) schedule;
and a second traffic identifier of a second low-latency traffic mapped between the AP and a member of the first R-TWT schedule includes a first traffic identifier of the first low-latency traffic;
and sending the first wireless frame.

In an aspect, the embodiments of the present disclosure provide a low-latency traffic transmission method performed by a first tunneled direct link setup (TDLS) device, and the method includes:
receiving a first wireless frame;
in which the first wireless frame includes first identification information, and the first identification information identifies that an access point (AP) allocates a slot of a transmission opportunity (TXOP) to the first TDLS device;
in which the slot of the TXOP is used for the first TDLS device and a second TDLS device to transmit a first low-latency traffic via a TDLS link; the first TDLS device is a member of a first restricted target wake time (R-TWT) schedule;
and a second traffic identifier of a second low-latency traffic mapped between the AP and a member of the first R-TWT schedule includes a first traffic identifier of the first low-latency traffic.

In an aspect, the embodiments of the present disclosure provide an access point (AP), and the AP includes: a memory, a processor, and a computer program stored on the memory and runnable on the processor; and the processor is configured to:
determine a first wireless frame, in which the first wireless frame includes first identification information, and the first identification information identifies that the AP allocates a slot of a transmission opportunity (TXOP) to a first tunneled direct link setup (TDLS) device;
in which the slot of the TXOP is used for the first TDLS device and a second TDLS device to transmit a first low-latency traffic via a TDLS link; the first TDLS device is a member of a first restricted target wake time (R-TWT) schedule;
and a second traffic identifier of a second low-latency traffic mapped between the AP and a member of the first R-TWT schedule includes a first traffic identifier of the first low-latency traffic;
send the first wireless frame.

### BRIEF DESCRIPTION OF THE DRAWINGS

In order to explain technical solutions in the embodiments of the present disclosure more clearly, the drawings described in the embodiments of the disclosure will be briefly introduced below. Obviously, the drawings described below are merely some embodiments of the disclosure. For ordinary technicians in the field, without the need for creative efforts, other drawings may be obtained based on these drawings.

FIG. 1 is an interactive schematic diagram of a low-latency traffic transmission method provided by an embodiment of the present disclosure;

FIG. 2 is a flowchart illustrating a low-latency traffic transmission method provided in an embodiment of the present disclosure;

FIG. 3 is a flowchart illustrating a low-latency traffic transmission method provided in an embodiment of the present disclosure;

FIG. 4 is a flowchart illustrating a low-latency traffic transmission method provided in an embodiment of the present disclosure;

FIG. 5 is a block diagram illustrating an electronic device provided in an embodiment of the present disclosure;

FIG. 6 is a block diagram illustrating an electronic device provided in an embodiment of the present disclosure;

FIG. 7 is a block diagram illustrating an electronic device provided in an embodiment of the present disclosure;

FIG. 8 is a block diagram illustrating an electronic device provided in an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terms used in the embodiment of the present disclosure are merely for the purpose of describing a particular embodiment and are not intended to limit the embodiment of the present disclosure. The terms “a” and “the” in the singular form as used in the embodiment of the present disclosure and the accompanying claims are also intended to include the majority form, unless the context clearly indicates otherwise. It should also be understood that the term “and/or” as used herein refers to and encompasses any or all possible combinations of one or more associated listed items. For example, “A and/or B” may represent three situations: A exists alone, A and B exist simultaneously, or B exists alone. The character “/” generally indicates that the objects before and after it have a “or” relationship. The term “multiple” means two or more. Given this, in the embodiments of the present disclosure, “multiple” may also be understood as “at least two”.

It is understood that although the terms first, second, third, etc. may be used to describe various information in the embodiments of the present disclosure, such information should not be limited to these terms. These terms are used only to distinguish the same type of information from one to another. For example, without leaving the scope of the present disclosure, the first information may also be referred to as the second information, and similarly, the second information may also be referred to as the first information. Depending on the context, the words “if” used here can be interpreted as “in a case where”, “when” or “in response to determining”.

In conjunction with the drawings in the embodiments of the present disclosure, the technical solutions in the embodiments of the present disclosure will be clearly and completely described below. Obviously, the described embodiments are only some embodiments of the present disclosure, but not all the embodiments. Based on the embodiments of the present disclosure, all other embodiments obtained by ordinary technicians in the field without making creative efforts fall within the protection scope of this disclosure.

The embodiments of the present disclosure provide a low-latency traffic transmission method, an electronic device, and a storage medium, so as to provide a transmission method for low-latency traffic data.

The method and the apparatus are based on the same application concept. Since the method and the apparatus have similar principles for solving problems, for implementations of the apparatus and the method, reference may be made to each other. The repetitive parts will not be elaborated again.

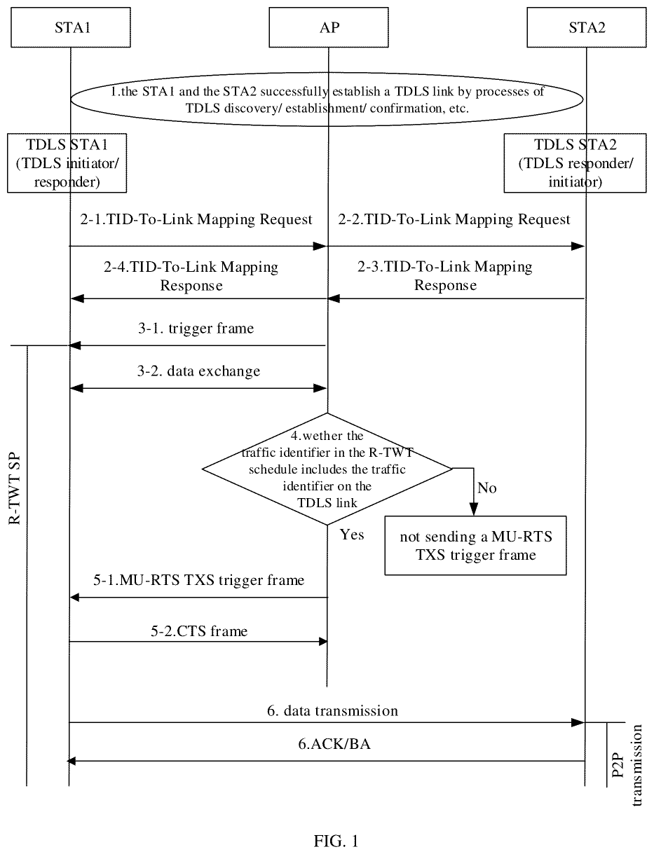

As a first example, referring to FIG. 1, an example of a low-latency traffic transmission method provided in an embodiment of the present disclosure is described. As shown in FIG. 1, an access point (AP), a station 1 (STA1, such as a first tunneled direct link setup (TDLS) device) and a STA2 (such as a second TDLS device) are in the same basic service set (BSS). The STA1 and the STA2 are peer devices, and all operations of the STA1 in the embodiments may also be performed by the STA2 in a peer manner. In the embodiments of the present disclosure, the STA1 and the STA2 may be collectively referred to as STA, in which the STA may also be a non-AP multi-link device (MLD).

Optionally, a restricted target wake time (R-TWT) planning device (such as the AP, also called a scheduling AP) and a planned device (such as the STA, also called a scheduled STA) may pre-establish an R-TWT schedule. The AP broadcasts the R-TWT schedule. The STA negotiates with the AP and becomes a member of the R-TWT schedule. The AP and the STA only transmit low-latency traffic corresponding to uplink and downlink of an identifier of the R-TWT schedule during a corresponding R-TWT service period, and other communication traffics are suspended or postponed during this period.

In the embodiments of the present disclosure, in a case that a second traffic identifier of a second low-latency traffic mapped between the AP and a member of the R-TWT schedule includes a first traffic identifier of a first low-latency traffic transmitted by a TDLS link, only one of the STA1 and the STA2 needs to be a member of the R-TWT schedule (that is, the STA1 or the STA2 is the member of the R-TWT schedule), so that the AP may allocate a slot of a transmission opportunity (TXOP) to the STA1 or the STA2, and the STA1 and the STA2 may transmit the first low-latency traffic via the TDLS link. Therefore, the low-latency traffic transmission method of the embodiments of the present disclosure is not limited to a situation where each the TDLS STA is the member of the R-TWT schedule, which further improves the flexibility and transmission efficiency of low-latency traffic transmission.

As shown in FIG. 1, the interactive process shown in FIG. 1 includes steps of low-latency traffic transmission between TDLS devices and negotiation steps of TDLS link traffic identifier to link mapping before the low-latency traffic transmission. Specifically, the processing steps shown in FIG. 1 may include the following steps.

Step 1: the STA1 and the STA2 successfully establish a TDLS link by processes of TDLS discovery, establishment, confirmation, etc. After the TDLS link is established, the STA1 may be used as a TDLS STA1 (i.e., a TDLS initiator or responder); correspondingly, the STA2 may be used as a TDLS STA2 (i.e., a TDLS responder or initiator).

Step 2-1: the AP receives a traffic identifier to link (TID-To-Link) Mapping request frame sent by the STA1. The TID-To-Link Mapping request frame carries a TID-To-Link Mapping element. The TID-To-Link Mapping element may include a TDLS link traffic identifier (TID) Mapping identification bit (i.e. it is a field). The TDLS TID Mapping identification bit is used to identify whether parameter information carried by the TID-To-Link Mapping element is used for traffic identifier mapping on a TDLS link between TDLS devices.

As an example, the format of the TID-To-Link Mapping element is shown in Table 1 below.

TABLE 1

| | | | | |
|---|---|---|---|---|
| Direction | Default | . . . | TDLS TID | Link Mapping Presence |
| | Link | | Mapping | Indicator |
| | Mapping | | | |

As an example, in a case that the TDLS TID Mapping identification bit is set to 1, it may identify that the parameter information carried by the TID-To-Link Mapping element is used for traffic identifier mapping on the TDLS link between the TDLS devices. In a case that the TDLS TID Mapping identification bit is set to 0, it may identify that the parameter information carried by the TID-To-Link Mapping element is not used for traffic identifier mapping on the TDLS link between the TDLS devices.

Optionally, the TID-To-Link Mapping element includes a direction identification bit; in which the direction identification bit is set to a first parameter value, indicating that a TID-To-Link mapping relationship included in the TID-To-Link Mapping element is TDLS link peer-to-peer transmission. For example, the first parameter value may be 3.

As an example, in a case that the parameter information carried by the TID-To-Link Mapping element is used for traffic identifier mapping on the TDLS link between the TDLS devices (i.e., the TDLS TID Mapping identification bit is set to 1), and the direction identification bit is set to 3, it may identify that the TID-To-Link mapping relationship included in the TID-To-Link Mapping element is the TDLS link peer-to-peer transmission, that is, the traffic transmission mapped on the TDLS link is TDLS device bidirectional peer to peer.

Step 2-2: the AP forwards the TID-To-Link Mapping request frame to the STA2. It may be understood that in the embodiments of the present disclosure, the TID-To-Link Mapping request frame is forwarded by the AP to the STA2.

Step 2-3: the AP receives a TID-To-Link Mapping response frame sent by the STA2. The TID-To-Link Mapping response frame carries the TID-To-Link Mapping element.

Step 2-4: the AP forwards the TID-To-Link Mapping response frame to the STA1. It may be understood that in the embodiments of the present disclosure, the TID-To-Link Mapping response frame is forwarded by the AP to the STA1.

Optionally, in the embodiments of the present disclosure, a parameter of the TDLS TID Mapping identification bit in the TID-To-Link Mapping request frame is the same as a parameter of the TDLS TID Mapping identification bit in the TID-To-Link Mapping response frame; and/or a parameter of a direction identification bit in the TID-To-Link Mapping request frame is the same as a parameter of a direction identification bit in the TID-To-Link Mapping response frame. In this way, it may identify that the STA2 supports peer-to-peer transmission of a low-latency traffic on the TDLS link.

Step 3-1: in a case that a target wake up time of an R-TWT schedule joined by the STA1 is reached, the AP sends a trigger frame (e.g., a basic trigger frame) to the STA1 to wake up the STA1 so as to exchange data with the STA1 within an R-TWT service period (SP).

Step 3-2: the AP exchanges data with the STA1 based on a low-latency communication traffic identifier mapped on the link. In a process of data exchange, the exchanged data may be a separate data frame or a plurality of consecutive data frames (i.e., a data block).

Step 4: the AP determines whether a traffic mapped in the traffic identifier on the TDLS link includes one or more low-latency traffics indicated by the traffic identifier in the R-TWT schedule, that is, whether a traffic type in a first traffic identifier of the first low-latency traffic transmitted by the TDLS link includes one or more low-latency traffics indicated by the second traffic identifier of the second low-latency traffic mapped between the AP and the member of the R-TWT schedule.

For example, second low-latency traffics mapped between the AP and the member of the R-TWT schedule (the member of the R-TWT schedule is the STA1) include traffic 1, traffic 3, traffic 5 and traffic 6, that is, in a corresponding R-TWT SP, a transmission identifier between the AP and the STA1 is the second low-latency traffic, and other traffics are suspended or postponed in the SP. Accordingly, the second traffic identifiers include identifier 1, identifier 3, identifier 5 and identifier 6 corresponding to the above traffics respectively. In a case that the first low-latency traffic(s) mapped by the TDLS link between the TDLS devices includes one or more traffic types of traffic 1, traffic 3, traffic 5 and traffic 6 (for example, the first traffic types include traffic 0, traffic 1, traffic 4 and traffic 6, that is, the first traffic identifiers include identifier 0, identifier 1, identifier 4 and identifier 6 corresponding to the above traffics respectively), in this example, the low-latency traffics of the second traffic identifiers (that is, identifier 1, identifier 3, identifier 5 and identifier 6) include the first traffic identifiers (identifier 1 and identifier 6).

Step 5-1: in a case that the AP determines that the traffic identifier in the R-TWT schedule includes the traffic identifier on the TDLS link, the AP sends a multi-user request to send (MU-RTS) transmission opportunity (TXOP) sharing (TXS) Trigger frame (i.e., a first wireless frame) to the STA1, and allocates a slot of the TXOP to the STA1 via a TXOP sharing method within the R-TWT SP. The slot of the TXOP is used for the STA1 and the STA2 to transmit the first low-latency traffic via the TDLS link.

In one embodiment, in a case that the traffic identifier in the R-TWT schedule does not include the traffic identifier on the TDLS link, the AP does not send the MU-RTS TXS Trigger frame.

Step 5-2: after receiving the MU-RTS TXS Trigger frame, the STA1 sends a clear to send (CTS) frame to the AP, that is, as a response to the MU-RTS TXS Trigger frame sent by the AP.

Step 6: in an allocated slot of the TXOP, the STA1 and the STA2 perform peer-to-peer (P2P) transmission via the TDLS link, that is, the STA1 sends data to the STA2.

During a data transmission process, after a receiver (i.e., the STA2) receives a data frame sent by a sender (i.e., the STA1), the receiver may feedback an acknowledgment message (ACK) frame to the sender. In a case that the receiver receives a plurality of consecutive data frames sent by the sender, the receiver may feedback a block Ack (BA) frame to the sender.

It should be noted that, as described above, the STA1 and the STA2 are peer devices. For example, when the STA1 is the initiator, the STA2 is the responder; when the STA2 is the initiator, the STA1 is the responder. The above embodiment is illustrated by taking the STA1 sending data to the STA2 as an example (the STA1 is the initiator and the STA2 is the responder), and the method is also applicable to the situation where the STA2 sends data to the STA1 (the STA2 is the initiator and the STA1 is the responder). Specifically, taking the main execution steps as an example: in step 3-2, the AP may also exchange data with the STA2. Correspondingly, in step 4, the AP may also send the MU-RTS TXS trigger frame to the STA2 in a case that the AP determines that the traffic identifier in the R-TWT schedule includes the traffic identifier on the TDLS link; in step 5-2, the STA2 may send the CTS frame to the AP; and in step 6, the STA2 and the STA1 perform P2P transmission, that is, the STA2 sends data to the STA1.

In the embodiments of the present disclosure, the AP uses first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established therebetween without the participation of the AP, thereby further reducing the transmission delay in the process of the low-latency traffic data transmission and improving the low-latency traffic transmission efficiency.

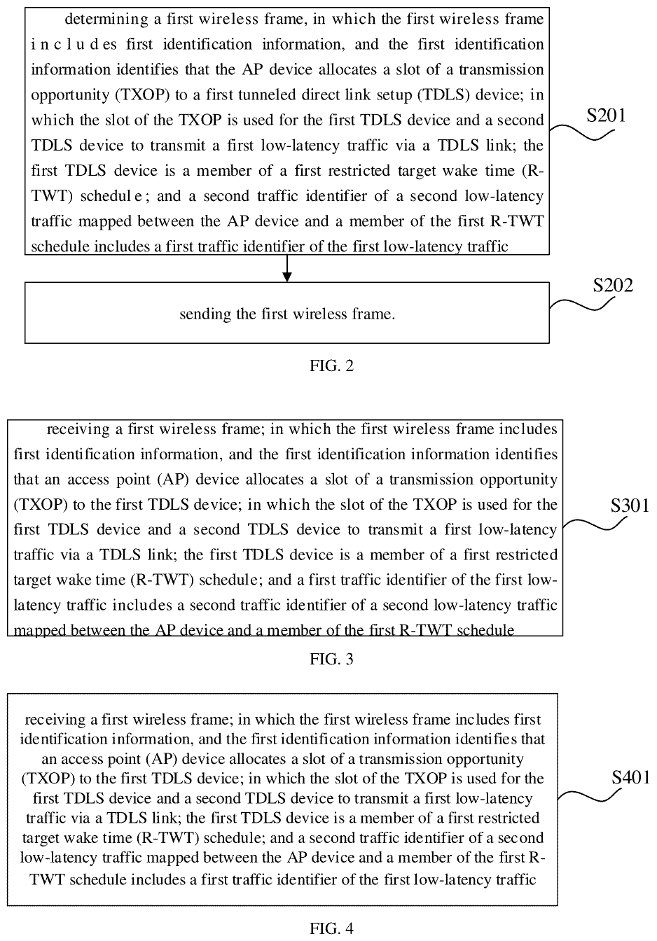

Referring to FIG. 2, an embodiment of the present disclosure provides a low-latency traffic transmission method. Optionally, the method may be performed by an access point (AP). Optionally, in the embodiments of the present disclosure, the AP is, for example, a device having a wireless to wired bridging function, and the AP is responsible for extending a service provided by a wired network to a wireless network. A station (STA) is, for example, an electronic device having a wireless network access function, and provides a frame delivery service to enable information to be transmitted. Optionally, in the embodiments of the present disclosure, the AP and the STA may be devices that support multiple links. For example, the AP and the STA may be represented as an AP MLD and a non-AP MLD, respectively. The AP MLD may represent an access point that supports a multi-link communication function, and the non-AP MLD may represent a station that supports the multi-link communication function.

The method may include the following steps.

Step 201, a first wireless frame is determined, in which the first wireless frame includes first identification information, and the first identification information identifies that the AP allocates a slot of a transmission opportunity (TXOP) to a first tunneled direct link setup (TDLS) device.

The slot of the TXOP is used for the first TDLS device and a second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

Step 202, the first wireless frame is sent.

Target wake time (TWT) is a technology used for energy saving, which aims to further reduce power consumption of the Wi-Fi network. Specifically, the TWT technology enables the STA and the AP to negotiate service time so as to determine time and frequency of sleep and wake up of the STA. The STA remains active and communicates during the service time, so that the STA may sleep outside the service time to achieve the purpose of energy saving. In addition, the TWT technology may also enable the AP to provide a higher quality service to a plurality of STAs, minimize competition or overlap, and improve spectrum efficiency while reducing the power consumption of the Wi-Fi network.

In a low-latency transmission scenario, real time data traffic of more applications has strict delay requirements. For example, the average delay or maximum delay is on the order of a few milliseconds to tens of milliseconds, and the applications require real time data traffic to have extremely small jitter and strong reliability. In order to further ensure the communication of low-latency traffics, based on the TWT technology, a restricted target wake time (R-TWT) is proposed. The R-TWT mechanism allows the AP to use enhanced media access protection mechanisms and resource reservation mechanisms to provide more predictable delays, so as to distinguish delay sensitive traffic from other types of traffics, so that the AP may reduce the worst case delay and/or reduce jitter, and provide more reliable services.

In the embodiments of the present disclosure, an R-TWT planning device (such as the AP, also called a scheduling AP) and a planned device (such as the STA, also called a scheduled STA) may pre-establish an R-TWT schedule. The AP broadcasts the R-TWT schedule. The STA negotiates with the AP and becomes a member of the R-TWT schedule. The AP and the STA only transmit low-latency traffic corresponding to uplink and downlink of an identifier of the R-TWT schedule during a corresponding R-TWT service period, and other communication traffics are suspended or postponed during this period. Specifically, the R-TWT is used to serve a low-latency traffic, such as traffic with an average delay less than 10 milliseconds. Within a service period (SP) of the R-TWT schedule, only traffics identified as low-latency traffics are communicated, and other communication traffics are suspended or postponed in this period, thereby ensuring the transmission of the low-latency traffics.

The AP determines the first wireless frame, in which the first wireless frame includes the first identification information, and the first identification information identifies that the AP allocates the slot of the TXOP to the first TDLS device; in which the slot of the TXOP is used for the first TDLS device and the second TDLS device to transmit the first low-latency traffic via the TDLS link; the first TDLS device is the member of the first R-TWT schedule; and the second traffic identifier of the second low-latency traffic mapped between the AP and the member of the first R-TWT schedule includes the first traffic identifier of the first low-latency traffic.

Furthermore, the first wireless frame is sent. For example, the AP may send the first wireless frame within the SP of the first R-TWT schedule.

Optionally, in the embodiments of the present disclosure, the first wireless frame includes a multi-user request to send (MU-RTS) TXOP sharing (TXS) trigger frame.

The first TDLS device and the second TDLS device may be, such as, two STAs. A TDLS technology enables two STAs in the same basic service set to directly skip the AP to transmit data after establishing a TDLS link (i.e., TDLS link/TDLS channel), so that they are not constrained by the AP and use the fastest rate standard supported by the two STAs for direct transmission. The direct transmission may be carried out on an original link or switched to a new extended channel, so as to avoid a data transmission delay caused by network congestion, which is of great significance for the transmission of the low-latency traffic.

In the embodiments of the present disclosure, the first TDLS device is a member of the first R-TWT schedule. That is to say, in a case that the second traffic identifier includes the first traffic identifier, only one of the first TDLS device and the second TDLS device needs to be the member of the first R-TWT schedule, and the AP may allocate the slot of the TXOP to the first TDLS device for the first TDLS device and the second TDLS device to transmit the first low-latency traffic via the TDLS link. Therefore, the embodiments of the present disclosure are not only limited to the situation where each TDLS station device is the member of the R-TWT schedule, thereby further improving the flexibility and transmission efficiency of low-latency traffic transmission.

For example, second low-latency traffics mapped between the AP and the member of the R-TWT schedule (the member of the R-TWT schedule is the STA1) include traffic 1, traffic 3, traffic 5 and traffic 6, that is, in a corresponding R-TWT SP, a transmission identifier between the AP and the STA1 is the second low-latency traffic, and other traffics are suspended or postponed in the SP. Accordingly, the second traffic identifiers include identifier 1, identifier 3, identifier 5 and identifier 6 corresponding to the above traffics respectively. Assume that the first low-latency traffic(s) mapped by the TDLS link between the TDLS devices includes one or more traffic types of traffic 1, traffic 3, traffic 5 and traffic 6 (for example, the first traffic types include traffic 0, traffic 1, traffic 4 and traffic 6, that is, the first traffic identifiers include identifier 0, identifier 1, identifier 4 and identifier 6 corresponding to the above traffics respectively). In this example, the low-latency traffics of the second traffic identifiers (that is, identifier 1, identifier 3, identifier 5 and identifier 6) include the first traffic identifiers (identifier 1 and identifier 6).

In the embodiment of the present disclosure, the AP uses the first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established between the two TDLS devices without the participation of the AP, thereby further reducing the transmission delay in the process of the low-latency traffic data transmission and improving the low-latency traffic transmission efficiency.

An embodiment of the present disclosure provides a low-latency traffic transmission method, performed by an access point (AP). The method may include the following steps.

A first wireless frame is determined, in which the first wireless frame includes first identification information, and the first identification information identifies that the AP allocates a slot of a transmission opportunity (TXOP) to a first tunneled direct link setup (TDLS) device.

The slot of the TXOP is used for the first TDLS device and a second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

The first wireless frame is sent.

Before determining the first wireless frame, the method further includes the following steps.

A second wireless frame sent by the first TDLS device is received; in which the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

The second wireless frame is sent to the second TDLS device.

Optionally, in the embodiment of the present disclosure, before determining the first wireless frame, a negotiation step of the TDLS link traffic identifier to link mapping may also be included.

As an example, the negotiation step may include the following steps.

The AP may receive the second wireless frame sent by the first TDLS device, and forward the second wireless frame to the second TDLS device. It may be understood that in the embodiment of the present disclosure, the second wireless frame is forwarded by the AP to the second TDLS device.

The second wireless frame may carry the first traffic identifier to link (TID-To-Link) Mapping element. The first TID-To-Link Mapping element includes the TDLS traffic identifier (TID) Mapping identification bit, and the TDLS TID Mapping identification bit identifies whether the parameter information carried by the first TID-To-Link Mapping element is used for the traffic identifier mapping on the TDLS link between the TDLS devices.

Optionally, the first TID-To-Link Mapping element is a traffic identifier to link (TID-To-Link) Mapping element; and the TDLS TID Mapping identification bit is a TDLS link traffic identifier (TID) Mapping identification bit.

As an example, the format of the first TID-To-Link Mapping element is as shown in Table 1 above.

As an example, in a case that the TDLS TID Mapping identification bit is set to 1, it may identify that the parameter information carried by the TID-To-Link Mapping element is used for traffic identifier mapping on the TDLS link between the TDLS devices. In a case that the TDLS TID Mapping identification bit is set to 0, it may identify that the parameter information carried by the TID-To-Link Mapping element is not used for traffic identifier mapping on the TDLS link between the TDLS devices.

Optionally, in the embodiment of the present disclosure, the second wireless frame may be a TID-To-Link Mapping request frame.

Optionally, in the embodiment of the present disclosure, the first TID-To-Link Mapping element includes a direction identification bit.

The direction identification bit is set to a first parameter value, indicating that a TID-To-Link mapping relationship included in the first TID-To-Link Mapping element is TDLS link peer-to-peer transmission.

For example, the first parameter value may be 3.

As an example, in a case that the parameter information carried by the TID-To-Link Mapping element is used for traffic identifier mapping on the TDLS link between the TDLS devices (i.e., the TDLS TID Mapping identification bit is set to 1), and the direction identification bit is set to 3, it may identify that the TID-To-Link mapping relationship included in the first TID-To-Link Mapping element is the TDLS link peer-to-peer transmission, that is, the traffic transmission mapped on the TDLS link is TDLS device bidirectional peer to peer.

An embodiment of the present disclosure provides a low-latency traffic transmission method, performed by an access point (AP). The method may include the following steps.

A first wireless frame is determined, in which the first wireless frame includes first identification information, and the first identification information identifies that the AP allocates a slot of a transmission opportunity (TXOP) to a first tunneled direct link setup (TDLS) device.

The slot of the TXOP is used for the first TDLS device and a second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

The first wireless frame is sent.

Before determining the first wireless frame, the method further includes the following steps.

A second wireless frame sent by the first TDLS device is received; in which the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

The second wireless frame is sent to the second TDLS device.

After sending the second wireless frame to the second TDLS device, the method further includes the following steps.

A third wireless frame sent by the second TDLS device is received, in which the third wireless frame includes a second TID-To-Link Mapping element.

The third wireless frame is sent to the first TDLS device.

Optionally, in the embodiment of the present disclosure, before determining the first wireless frame, a negotiation step of the TDLS link traffic identifier to link mapping may also be included.

As an example, the negotiation step may include the following steps.

After sending the second wireless frame to the second TDLS device, a third wireless frame sent by the second TDLS device is received, and the third wireless frame is forwarded to the first TDLS device. It may be understood that in the embodiment of the present disclosure, the third wireless frame is forwarded by the AP to the first TDLS device.

Specifically, the third wireless frame carries a second TID-To-Link Mapping element; in which the second TID-To-Link Mapping element is a TID-To-Link Mapping element.

Optionally, in the embodiment of the present disclosure, the third wireless frame may be a TID-To-Link Mapping response frame.

Optionally, in the embodiment of the present disclosure, a parameter of the TDLS TID Mapping identification bit of the second TID-To-Link Mapping element is the same as a parameter of the TDLS TID Mapping identification bit of the first TID-To-Link Mapping element;
and/or
a parameter of a direction identification bit of the second TID-To-Link Mapping element is the same as a parameter of a direction identification bit of the first TID-To-Link Mapping element;
identifying that the second TDLS device supports peer-to-peer transmission of a low-latency traffic on the TDLS link.

That is, a parameter of the TDLS TID Mapping identification bit in the second wireless frame is the same as a parameter of the TDLS TID Mapping identification bit in the third wireless frame; and/or a parameter of a direction identification bit in the second wireless frame is the same as a parameter of a direction identification bit in the third wireless frame. In this way, it may identify that the second TDLS device supports peer-to-peer transmission of a low-latency traffic on the TDLS link.

It should be noted that, as described above, the first TDLS device and the second TDLS device are peer devices, for example, when the first TDLS device is the initiator, the second TDLS device is the responder; when the second TDLS device is the initiator, the first TDLS device is the responder. The above embodiment is described by taking the first TDLS device sending data to the second TDLS device as an example (the first TDLS device is the initiator and the second TDLS device is the responder), and the method is also applicable to the situation where the second TDLS device sends data to the first TDLS device (the second TDLS device is the initiator and the first TDLS device is the responder).

In the embodiment of the present disclosure, the AP uses the first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established between the two TDLS devices without the participation of the AP, thereby further reducing the transmission delay in the process of the low-latency traffic data transmission and improving the low-latency traffic transmission efficiency.

An embodiment of the present disclosure provides a low-latency traffic transmission method, performed by an access point (AP). The method may include the following steps.

A first wireless frame is determined, in which the first wireless frame includes first identification information, and the first identification information identifies that the AP allocates a slot of a transmission opportunity (TXOP) to a first tunneled direct link setup (TDLS) device.

The slot of the TXOP is used for the first TDLS device and a second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

The first wireless frame is sent.

Optionally, before determining the first wireless frame, the method further includes the following steps.

A second wireless frame sent by the first TDLS device is received; in which the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

The second wireless frame is sent to the second TDLS device.

Optionally, the first TID-To-Link Mapping element includes a direction identification bit.

The direction identification bit is set to a first parameter value, indicating that a TID-To-Link mapping relationship included in the first TID-To-Link Mapping element is TDLS link peer-to-peer transmission.

Optionally, after sending the second wireless frame to the second TDLS device, the method further includes the following steps.

A third wireless frame sent by the second TDLS device is received, in which the third wireless frame includes a second TID-To-Link Mapping element.

The third wireless frame is sent to the first TDLS device.

Optionally, a parameter of the TDLS TID Mapping identification bit of the second TID-To-Link Mapping element is the same as a parameter of the TDLS TID Mapping identification bit of the first TID-To-Link Mapping element;
and/or
a parameter of a direction identification bit of the second TID-To-Link Mapping element is the same as a parameter of a direction identification bit of the first TID-To-Link Mapping element;
identifying that the second TDLS device supports peer-to-peer transmission of a low-latency traffic on the TDLS link.

Optionally, the second wireless frame includes a TID-To-Link Mapping request frame, and the third wireless frame includes a TID-To-Link Mapping response frame.

Optionally, the first wireless frame includes a multi-user request to send (MU-RTS) TXOP sharing (TXS) trigger frame.

In the embodiment of the present disclosure, the AP uses the first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established between the two TDLS devices without the participation of the AP, thereby further reducing the transmission delay in the process of the low-latency traffic data transmission and improving the low-latency traffic transmission efficiency.

Referring to FIG. 3, an embodiment of the present disclosure provides a low-latency traffic transmission method performed by a first tunneled direct link setup (TDLS) device. The method may include the following steps.

Step 301: a first wireless frame is received.

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; and the first TDLS device is a member of a first restricted target wake time (R-TWT) schedule.

A first traffic identifier of the first low-latency traffic includes a second traffic identifier of a second low-latency traffic mapped between the AP and a member of the first R-TWT schedule.

Optionally, in the embodiments of the present disclosure, the first wireless frame includes a multi-user request to send (MU-RTS) TXOP sharing (TXS) trigger frame.

The first TDLS device and the second TDLS device may be, such as, two STAs. A TDLS technology enables two STAs in the same basic service set to directly skip the AP to transmit data after establishing a TDLS link (i.e., TDLS link/TDLS channel), so that they are not constrained by the AP and use the fastest rate standard supported by the two STAs for direct transmission. The direct transmission may be carried out on an original link or switched to a new extended channel, so as to avoid a data transmission delay caused by network congestion, which is of great significance for the transmission of the low-latency traffic.

In the embodiments of the present disclosure, the first TDLS device is a member of the first R-TWT schedule. That is to say, in a case that the second traffic identifier includes the first traffic identifier, only one of the first TDLS device and the second TDLS device needs to be the member of the first R-TWT schedule, and the AP may allocate the slot of the TXOP to the first TDLS device for the first TDLS device and the second TDLS device to transmit the first low-latency traffic via the TDLS link. Therefore, the embodiments of the present disclosure are not only limited to the situation where all TDLS station devices are members of the R-TWT schedule, thereby further improving the flexibility and transmission efficiency of low-latency traffic transmission.

For example, second low-latency traffics mapped between the AP and the member of the R-TWT schedule (the member of the R-TWT schedule is the STA1) include traffic 1, traffic 3, traffic 5 and traffic 6, that is, in a corresponding R-TWT SP, a transmission identifier between the AP and the STA1 is the second low-latency traffic, and other traffics are suspended or postponed in the SP. Accordingly, the second traffic identifiers include identifier 1, identifier 3, identifier 5 and identifier 6 corresponding to the above traffics respectively. Assume that the first low-latency traffic(s) mapped by the TDLS link between the TDLS devices includes one or more traffic types of traffic 1, traffic 3, traffic 5 and traffic 6 (for example, the first traffic types include traffic 0, traffic 1, traffic 4 and traffic 6, that is, the first traffic identifiers include identifier 0, identifier 1, identifier 4 and identifier 6 corresponding to the above traffics respectively). In this example, the low-latency traffics of the second traffic identifiers (that is, identifier 1, identifier 3, identifier 5 and identifier 6) include the first traffic identifiers (identifier 1 and identifier 6).

In the embodiment of the present disclosure, the AP uses the first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established between the two TDLS devices without the participation of the AP, thereby further reducing the transmission delay in the process of the low-latency traffic data transmission and improving the low-latency traffic transmission efficiency.

An embodiment of the present disclosure provides a low-latency traffic transmission method. Optionally, the method is performed by a first tunneled direct link setup (TDLS) device and may include the following steps.

A first wireless frame is received.

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; and the first TDLS device is a member of a first restricted target wake time (R-TWT) schedule.

A first traffic identifier of the first low-latency traffic includes a second traffic identifier of a second low-latency traffic mapped between the AP and a member of the first R-TWT schedule.

Before receiving the first wireless frame, the method further includes the following steps.

A second wireless frame is determined, in which the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

The second wireless frame is sent.

Optionally, in the embodiment of the present disclosure, before determining the first wireless frame, a negotiation step of the TDLS link traffic identifier to link mapping may also be included.

As an example, the negotiation step may include the following steps.

The first TDLS device determines and sends the second wireless frame. The AP may receive the second wireless frame sent by the first TDLS device, and forward the second wireless frame to the second TDLS device. It may be understood that in the embodiment of the present disclosure, the second wireless frame is forwarded by the AP to the second TDLS device.

The second wireless frame may carry the first traffic identifier to link (TID-To-Link) Mapping element. The first TID-To-Link Mapping element includes the TDLS traffic identifier (TID) Mapping identification bit, and the TDLS TID Mapping identification bit identifies whether the parameter information carried by the first TID-To-Link Mapping element is used for the traffic identifier mapping on the TDLS link between the TDLS devices.

Optionally, the first TID-To-Link Mapping element is a traffic identifier to link (TID-To-Link) Mapping element; and the TDLS TID Mapping identification bit is a TDLS link traffic identifier (TID) Mapping identification bit.

As an example, the format of the first TID-To-Link Mapping element is as shown in Table 1 above.

As an example, in a case that the TDLS TID Mapping identification bit is set to 1, it may identify that the parameter information carried by the TID-To-Link Mapping element is used for traffic identifier mapping on the TDLS link between the TDLS devices. In a case that the TDLS TID Mapping identification bit is set to 0, it may identify that the parameter information carried by the TID-To-Link Mapping element is not used for traffic identifier mapping on the TDLS link between the TDLS devices.

Optionally, in the embodiment of the present disclosure, the second wireless frame may be a TID-To-Link Mapping request frame.

Optionally, in the embodiment of the present disclosure, the first TID-To-Link Mapping element includes a direction identification bit.

The direction identification bit is set to a first parameter value, indicating that a TID-To-Link mapping relationship included in the first TID-To-Link Mapping element is TDLS link peer-to-peer transmission.

For example, the first parameter value may be 3.

As an example, in a case that the parameter information carried by the TID-To-Link Mapping element is used for traffic identifier mapping on the TDLS link between the TDLS devices (i.e., the TDLS TID Mapping identification bit is set to 1), and the direction identification bit is set to 3, it may identify that the TID-To-Link mapping relationship included in the first TID-To-Link Mapping element is the TDLS link peer-to-peer transmission, that is, the traffic transmission mapped on the TDLS link is TDLS device bidirectional peer to peer.

An embodiment of the present disclosure provides a low-latency traffic transmission method. Optionally, the method is performed by a first tunneled direct link setup (TDLS) device and may include the following steps.

A first wireless frame is received.

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; and the first TDLS device is a member of a first restricted target wake time (R-TWT) schedule.

A first traffic identifier of the first low-latency traffic includes a second traffic identifier of a second low-latency traffic mapped between the AP and a member of the first R-TWT schedule.

Before receiving the first wireless frame, the method further includes the following steps.

A second wireless frame is determined, in which the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

The second wireless frame is sent.

After sending the second wireless frame, the method further includes the following steps.

A third wireless frame is received, in which the third wireless frame is forwarded by the AP from the second TDLS device, and the third wireless frame includes a second TID-To-Link Mapping element.

Specifically, the third wireless frame carries a second TID-To-Link Mapping element; in which the second TID-To-Link Mapping element is a TID-To-Link Mapping element.

Optionally, in the embodiment of the present disclosure, the third wireless frame may be a TID-To-Link Mapping response frame.

Optionally, in the embodiment of the present disclosure, a parameter of the TDLS TID Mapping identification bit of the second TID-To-Link Mapping element is the same as a parameter of the TDLS TID Mapping identification bit of the first TID-To-Link Mapping element;
and/or
a parameter of a direction identification bit of the second TID-To-Link Mapping element is the same as a parameter of a direction identification bit of the first TID-To-Link Mapping element;
identifying that the second TDLS device supports peer-to-peer transmission of a low-latency traffic on the TDLS link.

That is, a parameter of the TDLS TID Mapping identification bit in the second wireless frame is the same as a parameter of the TDLS TID Mapping identification bit in the third wireless frame; and/or a parameter of a direction identification bit in the second wireless frame is the same as a parameter of a direction identification bit in the third wireless frame. In this way, it may identify that the second TDLS device supports peer-to-peer transmission of a low-latency traffic on the TDLS link.

An embodiment of the present disclosure provides a low-latency traffic transmission method. Optionally, the method is performed by a first tunneled direct link setup (TDLS) device and may include the following steps.

A first wireless frame is received.

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; and the first TDLS device is a member of a first restricted target wake time (R-TWT) schedule.

A first traffic identifier of the first low-latency traffic includes a second traffic identifier of a second low-latency traffic mapped between the AP and a member of the first R-TWT schedule.

After the first wireless frame is received, the method further includes the following steps.

Low-latency traffic data is transmitted via the TDLS link with the second TDLS device in the slot of the TXOP.

As an example, within the R-TWT SP, the AP allocates a slot of the TXOP to the member station (for example, the first TDLS device) of the R-TWT schedule. After the station that obtains the TXOP replies with a CTS frame to the AP, this station may send the low-latency communication traffic to the corresponding TDLS station (for example, the second TDLS device) via the TDLS link within the obtained slot of the TXOP.

It should be noted that, as described above, the first TDLS device and the second TDLS device are peer devices, for example, when the first TDLS device is the initiator, the second TDLS device is the responder; when the second TDLS device is the initiator, the first TDLS device is the responder. The above embodiment is described by taking the first TDLS device sending data to the second TDLS device as an example (the first TDLS device is the initiator and the second TDLS device is the responder), and the method is also applicable to the situation where the second TDLS device sends data to the first TDLS device (the second TDLS device is the initiator and the first TDLS device is the responder).

An embodiment of the present disclosure provides a low-latency traffic transmission method. Optionally, the method is performed by a first tunneled direct link setup (TDLS) device and may include the following steps.

A first wireless frame is received.

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; and the first TDLS device is a member of a first restricted target wake time (R-TWT) schedule.

A first traffic identifier of the first low-latency traffic includes a second traffic identifier of a second low-latency traffic mapped between the AP and a member of the first R-TWT schedule.

Before receiving the first wireless frame, the method further includes the following steps.

A second wireless frame is determined, in which the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

The second wireless frame is sent.

Optionally, the first TID-To-Link Mapping element includes a direction identification bit.

The direction identification bit is set to a first parameter value, indicating that a TID-To-Link mapping relationship included in the first TID-To-Link Mapping element is TDLS link peer-to-peer transmission.

Optionally, after sending the second wireless frame, the method further includes the following steps.

A third wireless frame is received, in which the third wireless frame is forwarded by the AP from the second TDLS device, and the third wireless frame includes a second TID-To-Link Mapping element.

Optionally, in the embodiment of the present disclosure, a parameter of the TDLS TID Mapping identification bit of the second TID-To-Link Mapping element is the same as a parameter of the TDLS TID Mapping identification bit of the first TID-To-Link Mapping element;
and/or
a parameter of a direction identification bit of the second TID-To-Link Mapping element is the same as a parameter of a direction identification bit of the first TID-To-Link Mapping element;
identifying that the second TDLS device supports peer-to-peer transmission of a low-latency traffic on the TDLS link.

Optionally, after the first wireless frame is received, the method further includes the following steps.

Low-latency traffic data is transmitted via the TDLS link with the second TDLS device in the slot of the TXOP.

In the embodiment of the present disclosure, the AP uses the first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established between the two TDLS devices without the participation of the AP, thereby further reducing the transmission delay in the process of the low-latency traffic data transmission and improving the low-latency traffic transmission efficiency. The embodiment of the present disclosure provides a transmission method for low-latency traffic data.

Referring to FIG. 4, an embodiment of the present disclosure provides a low-latency traffic transmission method, performed by a second tunneled direct link setup (TDLS) device. The method may include the following steps.

Step 401: a first wireless frame is received.

The first wireless frame includes first identification information, and the first identification information identifies that an access point (AP) allocates a slot of a transmission opportunity (TXOP) to a first TDLS device.

The slot of the TXOP is used for the first TDLS device and the second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

Optionally, in the embodiment of the present disclosure, the first wireless frame includes a multi-user request to send (MU-RTS) TXOP sharing (TXS) trigger frame.

The first TDLS device and the second TDLS device may be, such as, two STAs. A TDLS technology enables two STAs in the same basic service set to directly skip the AP to transmit data after establishing a TDLS link (i.e., TDLS link/TDLS channel), so that they are not constrained by the AP and use the fastest rate standard supported by the two STAs for direct transmission. The direct transmission may be carried out on an original link or switched to a new extended channel, so as to avoid a data transmission delay caused by network congestion, which is of great significance for the transmission of the low-latency traffic.

In the embodiments of the present disclosure, the first TDLS device is a member of the first R-TWT schedule. That is to say, in a case that the second traffic identifier includes the first traffic identifier, only one of the first TDLS device and the second TDLS device needs to be the member of the first R-TWT schedule, and the AP may allocate the slot of the TXOP to the first TDLS device for the first TDLS device and the second TDLS device to transmit the first low-latency traffic via the TDLS link. Therefore, the embodiments of the present disclosure are not only limited to the situation where all TDLS station devices are members of the R-TWT schedule, thereby further improving the flexibility and transmission efficiency of low-latency traffic transmission.

For example, second low-latency traffics mapped between the AP and the member of the R-TWT schedule (the member of the R-TWT schedule is the STA1) include traffic 1, traffic 3, traffic 5 and traffic 6, that is, in a corresponding R-TWT SP, a transmission identifier between the AP and the STA1 is the second low-latency traffic, and other traffics are suspended or postponed in the SP. Accordingly, the second traffic identifiers include identifier 1, identifier 3, identifier 5 and identifier 6 corresponding to the above traffics respectively. Assume that the first low-latency traffic(s) mapped by the TDLS link between the TDLS devices includes one or more traffic types of traffic 1, traffic 3, traffic 5 and traffic 6 (for example, the first traffic types include traffic 0, traffic 1, traffic 4 and traffic 6, that is, the first traffic identifiers include identifier 0, identifier 1, identifier 4 and identifier 6 corresponding to the above traffics respectively). In this example, the low-latency traffics of the second traffic identifiers (that is, identifier 1, identifier 3, identifier 5 and identifier 6) include the first traffic identifiers (identifier 1 and identifier 6).

In the embodiment of the present disclosure, the AP uses the first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established between the two TDLS devices without the participation of the AP, thereby further reducing the transmission delay in the process of the low-latency traffic data transmission and improving the low-latency traffic transmission efficiency.

An embodiment of the present disclosure provides a low-latency traffic transmission method, performed by a second tunneled direct link setup (TDLS) device. The method may include the following steps.

A first wireless frame is received.

The first wireless frame includes first identification information, and the first identification information identifies that an access point (AP) allocates a slot of a transmission opportunity (TXOP) to a first TDLS device.

The slot of the TXOP is used for the first TDLS device and the second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

Before receiving the first wireless frame, the method further includes the following steps.

A second wireless frame is received, in which the second wireless frame is forwarded by the AP from the first TDLS device, and the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

Optionally, in the embodiment of the present disclosure, before determining the first wireless frame, a negotiation step of the TDLS link traffic identifier to link mapping may also be included.

As an example, the negotiation step may include the following steps.

The second TDLS device receives the second wireless frame, in which the second wireless frame is forwarded by the AP to the second TDLS device.

The second wireless frame may carry the first traffic identifier to link (TID-To-Link) Mapping element. The first TID-To-Link Mapping element includes the TDLS traffic identifier (TID) Mapping identification bit, and the TDLS TID Mapping identification bit identifies whether the parameter information carried by the first TID-To-Link Mapping element is used for the traffic identifier mapping on the TDLS link between the TDLS devices.

Optionally, the first TID-To-Link Mapping element is a traffic identifier to link (TID-To-Link) Mapping element; and the TDLS TID Mapping identification bit is a TDLS link traffic identifier (TID) Mapping identification bit.

As an example, the format of the first TID-To-Link Mapping element is as shown in Table 1 above.

As an example, in a case that the TDLS TID Mapping identification bit is set to 1, it may identify that the parameter information carried by the TID-To-Link Mapping element is used for traffic identifier mapping on the TDLS link between the TDLS devices. In a case that the TDLS TID Mapping identification bit is set to 0, it may identify that the parameter information carried by the TID-To-Link Mapping element is not used for traffic identifier mapping on the TDLS link between the TDLS devices.

Optionally, in the embodiment of the present disclosure, the second wireless frame may be a TID-To-Link Mapping request frame.

Optionally, in the embodiment of the present disclosure, the first TID-To-Link Mapping element includes a direction identification bit.

The direction identification bit is set to a first parameter value, indicating that a TID-To-Link mapping relationship included in the first TID-To-Link Mapping element is TDLS link peer-to-peer transmission.

For example, the first parameter value may be 3.

As an example, in a case that the parameter information carried by the TID-To-Link Mapping element is used for traffic identifier mapping on the TDLS link between the TDLS devices (i.e., the TDLS TID Mapping identification bit is set to 1), and the direction identification bit is set to 3, it may identify that the TID-To-Link mapping relationship included in the first TID-To-Link Mapping element is the TDLS link peer-to-peer transmission, that is, the traffic transmission mapped on the TDLS link is TDLS device bidirectional peer to peer.

An embodiment of the present disclosure provides a low-latency traffic transmission method, performed by a second tunneled direct link setup (TDLS) device. The method may include the following steps.

A first wireless frame is received.

The first wireless frame includes first identification information, and the first identification information identifies that an access point (AP) allocates a slot of a transmission opportunity (TXOP) to a first TDLS device.

The slot of the TXOP is used for the first TDLS device and the second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

Before receiving the first wireless frame, the method further includes the following steps.

A second wireless frame is received, in which the second wireless frame is forwarded by the AP from the first TDLS device, and the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

After the second wireless frame is received, the method further includes the following steps.

A third wireless frame is determined, in which the third wireless frame includes a second TID-To-Link Mapping element.

The third wireless frame is sent.

Specifically, the third wireless frame carries a second TID-To-Link Mapping element; in which the second TID-To-Link Mapping element is a TID-To-Link Mapping element.

Optionally, in the embodiment of the present disclosure, the third wireless frame may be a TID-To-Link Mapping response frame.

Optionally, in the embodiment of the present disclosure, a parameter of the TDLS TID Mapping identification bit of the second TID-To-Link Mapping element is the same as a parameter of the TDLS TID Mapping identification bit of the first TID-To-Link Mapping element;
and/or
a parameter of a direction identification bit of the second TID-To-Link Mapping element is the same as a parameter of a direction identification bit of the first TID-To-Link Mapping element;
identifying that the second TDLS device supports peer-to-peer transmission of a low-latency traffic on the TDLS link.

That is, a parameter of the TDLS TID Mapping identification bit in the second wireless frame is the same as a parameter of the TDLS TID Mapping identification bit in the third wireless frame; and/or a parameter of a direction identification bit in the second wireless frame is the same as a parameter of a direction identification bit in the third wireless frame. In this way, it may identify that the second TDLS device supports peer-to-peer transmission of a low-latency traffic on the TDLS link.

An embodiment of the present disclosure provides a low-latency traffic transmission method, performed by a second tunneled direct link setup (TDLS) device. The method may include the following steps.

A first wireless frame is received.

The first wireless frame includes first identification information, and the first identification information identifies that an access point (AP) allocates a slot of a transmission opportunity (TXOP) to a first TDLS device.

The slot of the TXOP is used for the first TDLS device and the second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

After the first wireless frame is received, the method further includes the following steps.

Low-latency traffic data is transmitted via the TDLS link with the second TDLS device in the slot of the TXOP.

As an example, within the R-TWT SP, the AP allocates a slot of the TXOP to the member station (for example, the first TDLS device) of the R-TWT schedule. After the station that obtains the TXOP replies with a CTS frame to the AP, this station may send the low-latency communication traffic to the corresponding TDLS station (for example, the second TDLS device) via the TDLS link within the obtained slot of the TXOP.

It should be noted that, as described above, the first TDLS device and the second TDLS device are peer devices, for example, when the first TDLS device is the initiator, the second TDLS device is the responder; when the second TDLS device is the initiator, the first TDLS device is the responder. The above embodiment is described by taking the first TDLS device sending data to the second TDLS device as an example (the first TDLS device is the initiator and the second TDLS device is the responder), and the method is also applicable to the situation where the second TDLS device sends data to the first TDLS device (the second TDLS device is the initiator and the first TDLS device is the responder).

An embodiment of the present disclosure provides a low-latency traffic transmission method, performed by a second tunneled direct link setup (TDLS) device. The method may include the following steps.

A first wireless frame is received.

The first wireless frame includes first identification information, and the first identification information identifies that an access point (AP) allocates a slot of a transmission opportunity (TXOP) to a first TDLS device.

The slot of the TXOP is used for the first TDLS device and the second TDLS device to transmit a first low-latency traffic via a TDLS link; and the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

Before receiving the first wireless frame, the method further includes the following steps.

A second wireless frame is received, in which the second wireless frame is forwarded by the AP from the first TDLS device, and the second wireless frame includes a first traffic identifier to link (TID-To-Link) Mapping element.

The first TID-To-Link Mapping element includes a TDLS traffic identifier (TID) Mapping identification bit, and the TDLS TID Mapping identification bit identifies whether parameter information carried by the first TID-To-Link Mapping element is used for traffic identifier mapping on a TDLS link between TDLS devices.

Optionally, the TID-To-Link Mapping element includes a direction identification bit.

The direction identification bit is set to a first parameter value, indicating that a TID-To-Link mapping relationship included in the first TID-To-Link Mapping element is TDLS link peer-to-peer transmission.

Optionally, after sending the second wireless frame, the method further includes the following steps.

A third wireless frame is received, in which the third wireless frame is forwarded by the AP from the second TDLS device, and the third wireless frame includes a second TID-To-Link Mapping element.

Optionally, a parameter of the TDLS TID Mapping identification bit of the second TID-To-Link Mapping element is the same as a parameter of the TDLS TID Mapping identification bit of the first TID-To-Link Mapping element;
and/or
a parameter of a direction identification bit of the second TID-To-Link Mapping element is the same as a parameter of a direction identification bit of the first TID-To-Link Mapping element; identifying that the second TDLS device supports peer-to-peer transmission of a low-latency traffic on the TDLS link.

Optionally, after the first wireless frame is received, the method further includes the following steps.

Low-latency traffic data is transmitted via the TDLS link with the second TDLS device in the slot of the TXOP.

In the embodiment of the present disclosure, the AP uses the first identification information to identify that the AP allocates the slot of the TXOP to the first TDLS device. For the R-TWT schedule applied between the STA devices, the first TDLS device and the second TDLS device may transmit the low-latency traffic data within the slot of the TXOP via the TDLS link established between the two TDLS devices without the participation of the AP, thereby further reducing the transmission delay in the process of the low-latency traffic data transmission and improving the low-latency traffic transmission efficiency. The embodiment of the present disclosure provides a transmission method for low-latency traffic data.

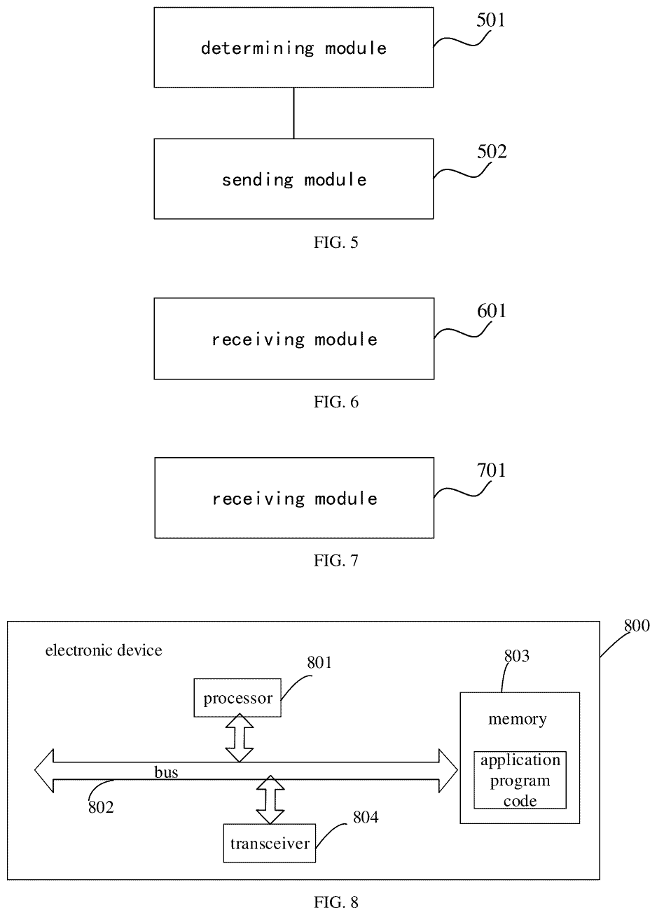

Refer to FIG. 5, based on the same principle as the method provided by the embodiments of the present disclosure, an embodiment of the present disclosure also provides an electronic device. The electronic device is applied to an access point (AP) and includes a determining module 501 and a sending module 502.

The determining module 501 is configured to determine a first wireless frame, in which the first wireless frame includes first identification information, and the first identification information identifies that the AP allocates a slot of a transmission opportunity (TXOP) to a first tunneled direct link setup (TDLS) device.

The slot of the TXOP is used for the first TDLS device and a second TDLS device to transmit a first low-latency traffic via a TDLS link. The first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

The sending module 502 is configured to send the first wireless frame.

An embodiment of the present disclosure also provides a low-latency traffic transmission apparatus. The apparatus is applied to an access point (AP) and includes the following modules.

A wireless frame determining module is configured to determine a first wireless frame, in which the first wireless frame includes first identification information, and the first identification information identifies that the AP allocates a slot of a transmission opportunity (TXOP) to a first tunneled direct link setup (TDLS) device.

The slot of the TXOP is used for the first TDLS device and a second TDLS device to transmit a first low-latency traffic via a TDLS link. The first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

A wireless frame sending module is configured to send the first wireless frame.

The apparatus also includes other modules of the electronic device as mentioned in the aforementioned embodiments, which will not be elaborated here.

Refer to FIG. 6, based on the same principle as the method provided by the embodiments of the present disclosure, an embodiment of the present disclosure also provides an electronic device. The electronic device is applied to a first tunneled direct link setup (TDLS) device and includes a receiving module 601.

The receiving module 601 is configured to receive a first wireless frame;

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

An embodiment of the present disclosure also provides a low-latency traffic transmission apparatus. The apparatus is applied to a first tunneled direct link setup (TDLS) device and includes the following module.

A wireless frame receiving module is configured to receive a first wireless frame;

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

The apparatus also includes other modules of the electronic device as mentioned in the aforementioned embodiments, which will not be elaborated here.

Refer to FIG. 7, based on the same principle as the method provided by the embodiments of the present disclosure, an embodiment of the present disclosure also provides an electronic device. The electronic device is applied to a second tunneled direct link setup (TDLS) device and includes a receiving module 701.

The receiving module 701 is configured to receive a first wireless frame;

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

An embodiment of the present disclosure also provides a low-latency traffic transmission apparatus. The apparatus is applied to a second tunneled direct link setup (TDLS) device and includes the following module.

A wireless frame receiving module is configured to receive a first wireless frame;

The first wireless frame includes first identification information, and the first identification information identifies that an access point (AP) allocates a slot of a transmission opportunity (TXOP) to the first TDLS device.

The slot of the TXOP is used for the first TDLS device and a second TDLS device to transmit a first low-latency traffic via a TDLS link; the first TDLS device is a member of a first restricted target wake time (R-TWT) schedule.

A second traffic identifier of a second low-latency traffic mapped between the AP and a member of the first R-TWT schedule includes a first traffic identifier of the first low-latency traffic.

The apparatus also includes other modules of the electronic device as mentioned in the aforementioned embodiments, which will not be elaborated here.

In an optional embodiment, the present disclosure also provides an electronic device. As shown in FIG. 8, the electronic device 800 shown in FIG. 8 may be a server and includes: a processor 801 and a memory 803. The processor 801 and the memory 803 are connected, such as through a bus 802. Optionally, the electronic device 800 may also include a transceiver 804. It should be noted that in actual applications, the number of transceivers 804 is not limited to one, and the structure of the electronic device 800 does not constitute a limitation to the present disclosure.

The processor 801 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. The processor 801 may be used for implementing or executing various logic blocks, modules, and circuits described in conjunction with the present disclosure. The processor 801 may also be a combination that implements computing functions, such as a combination of one or more microprocessors, a combination of a DSP and a microprocessor, etc.

The bus 802 may include a path for transmitting information among the aforementioned components. The bus 802 may be a peripheral component interconnect (PCI) bus or an extended industry standard architecture (EISA) bus, etc. The bus 802 may be classified into an address bus, a data bus, a control bus, etc. For ease of representation, only a thick line is used in FIG. 8 to represent the bus, but it does not imply that there is only one bus or only one type of buses.

The memory 803 may be a read only memory (ROM) or other types of static storage devices that may store static information and instructions, a random access memory (RAM) or other types of dynamic storage devices that may store information and instructions, an electrically erasable programmable read only memory (EEPROM), a compact disc read only memory (CD-ROM), or other optical disk storage media or optical disc storage media (including a compressed optical disk, a laser disk, an optical disk, a digital versatile disk, a Blu-ray disk, etc.), a magnetic disk storage medium or other magnetic storage devices, or any other medium that may be used to carry or store program codes in the form of instructions or data structures and may be accessed by a computer, but is not limited to this.

The memory 803 is used to store the application program code for implementing the technical solution of the present disclosure, and is controlled to execute by the processor 801. The processor 801 is used to execute the application program code stored in memory 803 to achieve the content as described in the aforementioned method embodiments.

The electronic device includes but is not limited to: a mobile terminal such as a mobile phone, a laptop, a digital radio receiver, a personal digital assistant (PDA), a tablet computer (PAD), a portable multimedia player (PMP), or a mobile terminal (such as an in-vehicle navigation terminal), etc., as well as a fixed terminal such as a digital TV, or a desktop computer, etc. The electronic device shown in FIG. 8 is merely an example and should not impose any limitations on the functions and usage scope of the present disclosure.

The server provided by the present disclosure may be an independent physical server, a server cluster composed of a plurality of physical servers, or a distributed system. It may also be a cloud server that provides basic cloud computing services such as a cloud service, a cloud database, cloud computing, a cloud function, cloud storage, a network service, cloud communication, a middleware service, a domain name service, a security service, CDN, and big data and an artificial intelligence platform. The terminal may be a smart phone, a tablet computer, a laptop computer, a desktop computer, a smart speaker, a smart watch, etc., but is not limited to these. The terminal and the server may be directly or indirectly connected through wired or wireless communication, which is not limited in the present disclosure.

The embodiments of the present disclosure provide a computer-readable storage medium, on which a computer program is stored. When the computer program is run on a computer, the computer is caused to execute the corresponding contents of the aforementioned method embodiments.

It should be understood that although the steps in the flowchart of the attached figures are displayed sequentially according to the arrows, these steps are not necessarily executed in the order indicated by the arrows. Unless explicitly stated in the disclosure, there is no strict sequence restriction on the execution of these steps, and they may be executed in other orders. Moreover, at least some of the steps in the flowchart of the attached figure may include multiple sub-steps or multiple stages. These sub-steps or stages do not necessarily need to be completed at the same time, but may be executed at different times, and their execution order does not necessarily proceed sequentially, but may be executed alternately or in rotation with at least some other steps or sub-steps or stages of other steps.

It should be noted that the computer-readable medium mentioned above in the disclosure may be a computer-readable signal medium, or a computer-readable storage medium, or any combination of the two. The machine-readable media may be such as, but are not limited to, electronic, magnetic, optical, electromagnetic, infrared, or semiconductor systems, apparatuses or devices, or any suitable combination thereof. More specific examples of machine-readable storage media may include electrical connections based on one or more wires, a portable computer disk, a hard disk, a random access memory (RAM), a read-only memory (ROM), an erasable programmable read only memory (EPROM or flash memory), an optical fiber, a compact disk read only memory (CD-ROM), an optical storage device, a magnetic storage device, or any suitable combination thereof. In the disclosure, the computer-readable storage medium may be any tangible medium that contains or stores a program, which may be executed by an instruction-executing system, device or component, or used in combination with it. In the disclosure, the computer-readable signal medium may include data signals carried in a baseband or as part of a carrier, where the data signals carry computer-readable program code. Such propagated data signals may take various forms, including but not limited to electromagnetic signals, optical signals, or any suitable combination of the above. The computer-readable signal medium may also be any computer-readable medium other than a computer-readable storage medium, and the computer-readable signal medium may send, propagate or transmit a program for use by an instruction-executing system, device or component or in combination with it. The program code contained in the computer-readable medium may be transmitted using any appropriate medium, including but not limited to: wires, optical cables, RF (radio frequency), etc., or any suitable combination of the above.

The above computer-readable medium may be contained within the above electronic device, or may exist independently and not be assembled into the electronic device.

The above computer-readable medium carries one or more programs. When these one or more programs are executed by the electronic device, the electronic device performs the method as described in the above embodiment.

According to one aspect of the present disclosure, a computer program product or a computer program is provided. The computer program product or the computer program includes a computer instruction, which is stored in the computer-readable storage medium. A processor of a computer device reads the computer instruction from the computer-readable storage medium, and the processor executes the computer instruction, thereby enabling the computer device to perform the methods provided in the various optional embodiments mentioned above.

Program codes configured to implement the methods in the present disclosure may be written in one or multiple programming languages, or any combination thereof. The programming languages include object-oriented programming languages such as Java, Smalltalk, C++, as well as conventional procedural programming languages such as “C” language or similar programming languages. The program codes may be executed entirely on a user computer, partially on a user computer, partially on a user computer and partially on a remote computer as a stand-alone software package, or entirely on a remote computer or a server. In a case that involving remote computers, the remote computer may be connected to the user computer through any type of networks, including local area networks (LANs) or wide area networks (WANs); or the remote computer may be connected to an external computer (for example, via the Internet by using an Internet service provider).

The flowcharts and block diagrams in the attached figures illustrate the possible architectures, functions and operations of the systems, methods and computer program products according to various embodiments of the present disclosure. In this regard, each box in the flowchart or block diagram may represent a module, a program segment, or a part of the code, which contains one or more executable instructions for implementing the specified logical functions. It should also be noted that in some alternative implementations, the functions indicated in the boxes may occur in a different order than that indicated in the figures. For example, two consecutive boxes may actually be executed in a basically parallel manner, and they may sometimes be executed in the opposite order, depending on the functions involved. It should also be noted that each box in the block diagram and/or flowchart, as well as the combinations of boxes in the block diagram and/or flowchart, may be implemented using a dedicated hardware-based system that performs the specified functions or operations, or using a combination of dedicated hardware and computer instructions.

The modules described in the present disclosure may be realized in a software manner or in a hardware manner. In some cases, the name of a module does not limit the module itself. For example, module A may also be described as “module A for performing operation B”.

The above description merely shows some embodiments of the present disclosure and an explanation of the technical principles. Those skilled in the art should understand that the scope of the disclosure herein is not limited to the technical solution formed by a specific combination of the aforementioned technical features, but also encompasses other technical solutions formed by any combination of the aforementioned technical features or their equivalents, without departing from the aforementioned disclosure concept. For example, such technical solutions may be formed by replacing the aforementioned features with the (but not limited to) technical features having similar functions disclosed in the present disclosure.

1. A low-latency traffic transmission method, performed by an access point (AP), comprising:
determining a first wireless frame, wherein the first wireless frame comprises first identification information that identifies that the AP allocates a slot of a transmission opportunity (TXOP) to a first tunneled direct link setup (TDLS) device;
wherein the slot of the TXOP is used for the first TDLS device and a second TDLS device to transmit a first low-latency traffic via a TDLS link; the first TDLS device is a member scheduled by a first restricted target wake time (R-TWT); and
a second traffic identifier of a second low-latency traffic mapped between the AP and a member scheduled by the first R-TWT comprises a first traffic identifier of the first low-latency traffic; and
sending the first wireless frame.

2. The low-latency traffic transmission method according to claim 1, wherein before determining the first wireless frame, the method further comprises:
receiving a second wireless frame sent by the first TDLS device; wherein the second wireless frame comprises a first traffic identifier to link (TID-To-Link) mapping element;
wherein the first TID-To-Link mapping element comprises a TDLS traffic identifier (TID) mapping identification bit, and the TDLS TID mapping identification bit identifies whether parameter information carried by the first TID-To-Link mapping element is used for traffic identifier mapping on a TDLS link between TDLS devices; and
sending the second wireless frame to the second TDLS device.

3. The low-latency traffic transmission method according to claim 2, wherein the first TID-To-Link mapping element comprises a direction identification bit;
wherein the direction identification bit is set to a first parameter value, indicating that a TID-To-Link mapping relationship in the first TID-To-Link mapping element is TDLS link peer-to-peer transmission.

4. The low-latency traffic transmission method according to claim 2, wherein after sending the second wireless frame to the second TDLS device, the method further comprises:
receiving a third wireless frame sent by the second TDLS device, wherein the third wireless frame comprises a second TID-To-Link mapping element; and
sending the third wireless frame to the first TDLS device.

5. The low-latency traffic transmission method according to claim 4, wherein the method comprises at least one of:
a parameter of the TDLS TID mapping identification bit of the second TID-To-Link mapping element is same as a parameter of the TDLS TID mapping identification bit of the first TID-To-Link mapping element;
or
a parameter of a direction identification bit of the second TID-To-Link mapping element is the same as a parameter of a direction identification bit of the first TID-To-Link mapping element;
identifying that the second TDLS device supports peer-to-peer transmission of a low-latency traffic on the TDLS link.

6. The low-latency traffic transmission method according to claim 4, wherein the second wireless frame comprises a TID-To-Link mapping request frame, and the third wireless frame comprises a TID-To-Link mapping response frame.

7. The low-latency traffic transmission method according to claim 1, wherein the first wireless frame comprises a multi-user request to send (MU-RTS) TXOP sharing (TXS) trigger frame.

8. A low-latency traffic transmission method, performed by a first tunneled direct link setup (TDLS) device, comprising:
receiving a first wireless frame;
wherein the first wireless frame comprises first identification information that identifies that an access point (AP) allocates a slot of a transmission opportunity (TXOP) to the first TDLS device;
wherein the slot of the TXOP is used for the first TDLS device and a second TDLS device to transmit a first low-latency traffic via a TDLS link; the first TDLS device is a member scheduled by a first restricted target wake time (R-TWT); and
a first traffic identifier of the first low-latency traffic comprises a second traffic identifier of a second low-latency traffic mapped between the AP and a member scheduled by the first R-TWT.

9. The low-latency traffic transmission method according to claim 8, wherein before receiving the first wireless frame, the method further comprises:
determining a second wireless frame, wherein the second wireless frame comprises a first traffic identifier to link (TID-To-Link) mapping element;
wherein the first TID-To-Link mapping element comprises a TDLS traffic identifier (TID) mapping identification bit, and the TDLS TID mapping identification bit identifies whether parameter information carried by the first TID-To-Link mapping element is used for traffic identifier mapping on a TDLS link between TDLS devices; and
sending the second wireless frame.

10. The low-latency traffic transmission method according to claim 9, wherein the first TID-To-Link mapping element comprises a direction identification bit;
wherein the direction identification bit is set to a first parameter value, indicating that a TID-To-Link mapping relationship in the first TID-To-Link mapping element is TDLS link peer-to-peer transmission.

11. The low-latency traffic transmission method according to claim 9, wherein after sending the second wireless frame, the method further comprises:
receiving a third wireless frame, wherein the third wireless frame is forwarded by the AP from the second TDLS device, and the third wireless frame comprises a second TID-To-Link mapping element.

12. The low-latency traffic transmission method according to claim 11, wherein the method comprises at least one of:
a parameter of the TDLS TID mapping identification bit of the second TID-To-Link mapping element is same as a parameter of the TDLS TID mapping identification bit of the first TID-To-Link mapping element;
or
a parameter of a direction identification bit of the second TID-To-Link mapping element is the same as a parameter of a direction identification bit of the first TID-To-Link mapping element;
identifying that the second TDLS device supports peer-to-peer transmission of a low-latency traffic on the TDLS link.

13. The low-latency traffic transmission method according to claim 8, wherein after receiving the first wireless frame, the method further comprises:
transmitting low-latency traffic data via the TDLS link with the second TDLS device in the slot of the TXOP.

14. An access point (AP), comprising:
a memory, a processor, and a computer program stored on the memory and runnable on the processor; and the processor is configured to:
determine a first wireless frame, wherein the first wireless frame comprises first identification information, and the first identification information identifies that the AP allocates a slot of a transmission opportunity (TXOP) to a first tunneled direct link setup (TDLS) device;
wherein the slot of the TXOP is used for the first TDLS device and a second TDLS device to transmit a first low-latency traffic via a TDLS link; the first TDLS device is a member scheduled by a first restricted target wake time (R-TWT); and
a second traffic identifier of a second low-latency traffic mapped between the AP and a member scheduled by the first R-TWT comprises a first traffic identifier of the first low-latency traffic; and
send the first wireless frame.

15. A first tunneled direct link setup (TDLS) device, comprising:
a memory, a processor, and a computer program stored on the memory and runnable on the processor; wherein when the computer program is executed by the processor, a method according to claim 8 is implemented.

16. (canceled)

17. A non-transitory computer-readable storage medium, wherein a computer program is stored on the computer-readable storage medium, and when the computer program is executed by a processor, a method according to claim 1.

18. A computer-readable storage medium, wherein a computer program is stored on the computer-readable storage medium, and when the computer program is executed by a processor, a method according to claim 8 is implemented.

19. The AP according to claim 14, wherein before the processor is configured to determine the first wireless frame, the processor is further configured to:
receive a second wireless frame sent by the first TDLS device; wherein the second wireless frame comprises a first traffic identifier to link (TID-To-Link) mapping element;
wherein the first TID-To-Link mapping element comprises a TDLS traffic identifier (TID) mapping identification bit, and the TDLS TID mapping identification bit identifies whether parameter information carried by the first TID-To-Link mapping element is used for traffic identifier mapping on a TDLS link between TDLS devices; and
send the second wireless frame to the second TDLS device.

20. The AP according to claim 19, wherein the first TID-To-Link mapping element comprises a direction identification bit;
wherein the direction identification bit is set to a first parameter value, indicating that a TID-To-Link mapping relationship in the first TID-To-Link mapping element is TDLS link peer-to-peer transmission.

21. The AP according to claim 19, wherein after the processor is configured to send the second wireless frame to the second TDLS device, the processor is further configured to:
receive a third wireless frame sent by the second TDLS device, wherein the third wireless frame comprises a second TID-To-Link mapping element; and
send the third wireless frame to the first TDLS device.
